(19) United States
(12) Patent Application Publication
(10) Pub. No.: US 2016/0376943 A1
(43) Pub. Date: Dec. 29, 2016

(54) BOLT VALVE

(71) Applicants: HYUNDAI MOTOR COMPANY, Seoul (KR); KIA MOTORS CORPORATION, Seoul (KR)

(72) Inventors: Chung Han OH, Seongnam-si (KR); Min Su PARK, Paju-si (KR); Yun Seok KIM, Yongin-si (KR); Jong Kuk PARK, Yongin-si (KR)

(73) Assignees: KIA MOTORS CORPORATION, Seoul (KR); HYUNDAI MOTOR COMPANY, Seoul (KR)

(21) Appl. No.: 14/947,519

(22) Filed: Nov. 20, 2015

(30) Foreign Application Priority Data
Jun. 26, 2015 (KR) 10-2015-0091599

(51) Int. Cl. F01L 1/344; B01D 35/00

(52) U.S. Cl. CPC F01L 1/3442; B01D 35/005; F01L 2001/34426; F01L 2001/3444

(57) ABSTRACT

A bolt valve includes a body having an oil channel longitudinally formed therein to discharge oil flowing in the oil channel. An oil filtering member is disposed in the body for filtering oil flowing into the oil channel.

### CROSS-REFERENCE TO RELATED APPLICATIONS

This application claims the benefit of Korean Patent Application No. 10-2015-0091599, filed on Jun. 26, 2015, the contents of which are incorporated herein by reference in its entirety.

### FIELD

The present disclosure relates to a structure for supplying oil to an intermediate phase continuous variable valve timing (“CVVT”) of a vehicle.

### BACKGROUND

The statements in this section merely provide background information related to the present disclosure and may not constitute prior art.

In general, a continuous variable valve timing system is a system that continuously changes opening/closing timings by changing the phase of a camshaft in accordance with the RPM of an engine and the load on a vehicle.

An automotive continuous variable valve timing system 101 in the related art, as shown in FIG. 1, includes: a crank angle sensor that senses a rotational angle of a crankshaft; a cam angle sensor that senses a rotational angle of a camshaft 104; a variable valve timing unit 150 that is connected to a side of the camshaft 104 by a timing belt and advances or retards the camshaft 104; and an ECU that controls an oil control valve 108 on the basis of signals from the crank angle sensor and the cam angle sensor so that oil is supplied to an advancing chamber 111a or a retarding chamber 111b of the variable valve timing unit 150.

Further, the variable valve timing unit 150 is composed of a stator 110 that is connected by a timing belt to receive torque from the crankshaft and a rotor 120 that is integrally coupled to the camshaft 104 and formed in the shape of a vane rotating relatively to the stator 110.

A chamber 111 divided into an advancing chamber 111a and a retarding chamber 111b by the rotor 120 is formed in the stator 110, so when oil is supplied to the advancing chamber 111a through an oil control valve 108, a phase difference is generated between the rotor 120 and the stator 110 and the camshaft 104 is rotated, thereby changing the timing of a valve.

When oil flows into the retarding chamber 111b through the oil control valve 108, a phase difference opposite to the phase difference described above is generated between the rotor 120 and the stator 110, thereby retarding the timing of the valve.

A locking pin 131 is formed on the rotor 120 so that the rotor 120 is locked to the stator 110 when an engine stops and a pin locking portion (not shown) for locking the locking pin 131 is formed on the stator 10. Oil supplied from the camshaft 104 is used to control the locking pin 131. However, foreign substances in the oil can accumulate in the oil channel and cause sticking.

### SUMMARY

The present disclosure provides a bolt valve for inhibiting sticking by removing foreign substances in oil supplied from a camshaft.

In one form of the present disclosure, there is provided a bolt valve including: a body having an oil channel longitudinally formed therein to discharge oil flowing in the oil channel; and an oil filtering member disposed in the body and filtering oil flowing into the oil channel.

A head may be disposed at a first end of the body and the oil filtering member may be disposed at a second end of the body.

The oil filtering member may be a mesh covering an end of the body.

In one form, the size of the mesh may be 150˜200 μm×150˜200 μm.

In another form, the oil filtering member may be fitted in the oil channel at an end of the body and positioned at an inlet of the oil channel.

The oil filtering member may have a semi-spherical shape concaved inside the oil channel at an end, so an area where the oil is filtered may be increased to reduce interfering with flow of the oil.

Diameters of the oil filtering member and the oil channel may be the same and the oil filtering member may be forcibly fitted (i.e., interference fit) in the oil channel.

Accordingly, the bolt valve adds the oil filtering member that filters one more time to the oil supplied to the CVVT through the camshaft from the oil tank. Therefore, it is possible to block or filter out foreign substances flowing into the CVVT without interfering with oil flow, thereby reducing the probability of the CVVT sticking.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view showing a CVVT system of the prior art;

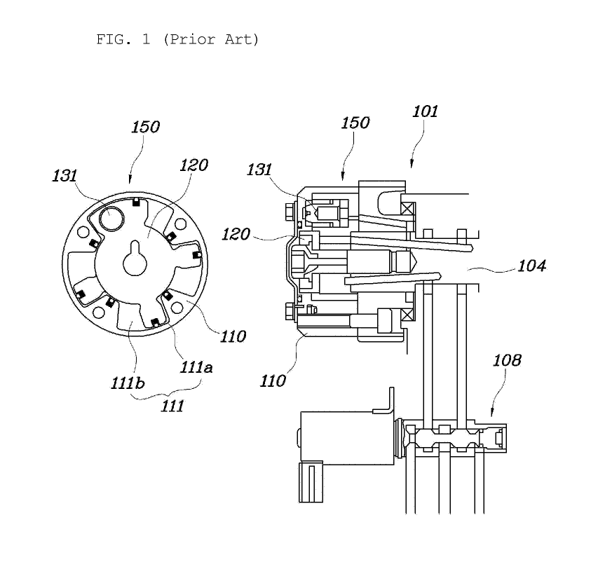

FIG. 2 is a view showing a bolt valve according to one form of the present disclosure; and

FIG. 3 is a view showing a state when one form of the bolt valve was mounted.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

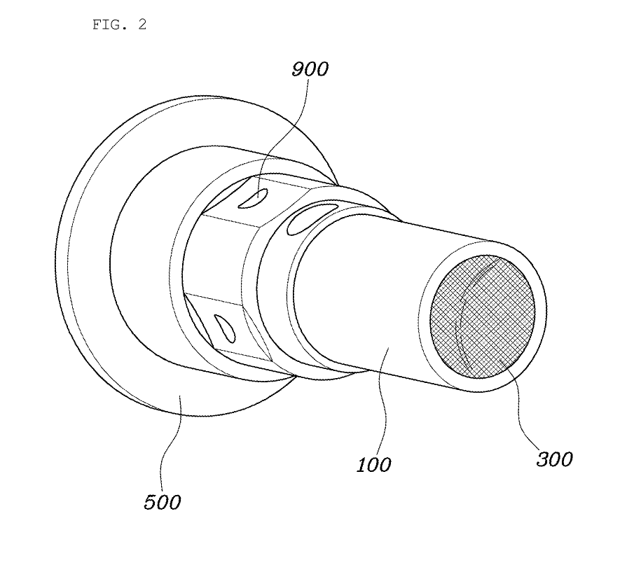

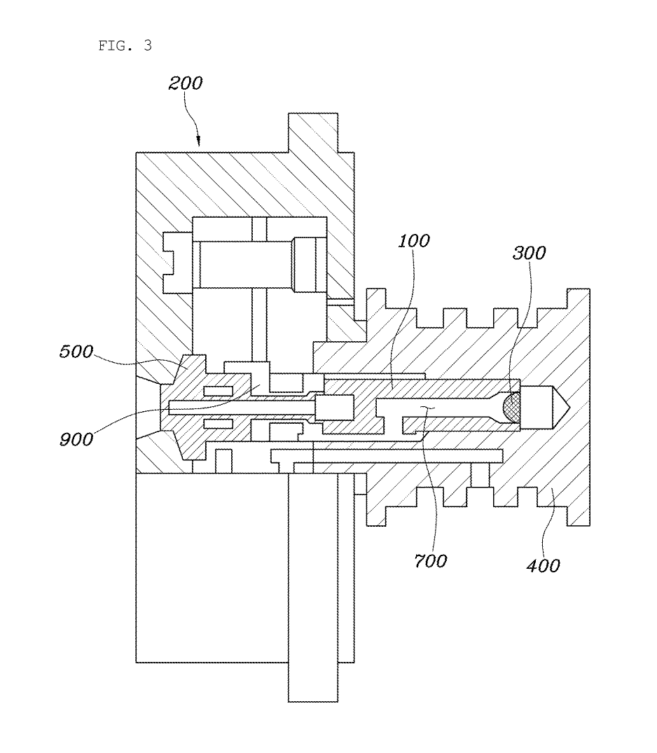

FIG. 2, is a view showing a bolt valve according to one form of the present disclosure and FIG. 3 is a view showing a state when one form of the bolt valve was mounted.

The bolt valve according to one form of the present disclosure includes: a body 100 that has an oil channel 700 longitudinally formed therein to discharge oil flowing in the oil channel 700; and an oil filtering member 300 that is disposed in the body 100 and filters oil flowing into the oil channel 700.

In one form, the bolt valve of the present disclosure is a bolt valve that controls an oil passage for controlling a locking pin particularly in an intermediate phase CVVT. A spool valve in the bolt valve is operated by a current of an actuator and sends oil supplied from a camshaft 400 to the intermediate phase CVVT. When there is a foreign substance in the supplied oil, the foreign substance flows into the bolt valve or the CVVT and may cause sticking of the CVVT. Accordingly, in one form of the present disclosure, the bolt valve includes the oil filtering member 300 to prevent foreign substances from flowing into the CVVT, so foreign substances in oil are filtered before the oil is supplied to the CVVT.

In one form, since the oil channel 700 is longitudinally formed in the body 100 of the bolt valve of the present disclosure, when oil flowing in the oil channel 700 operates a spool, an oil passage is formed between the outer side of the bolt valve and the inner side of the CVVT, so the oil is supplied to the locking pin. A head 500 is formed at a first end of the body 100 and the oil filtering member 300 for filtering oil flowing into the oil channel 700 is disposed at a second end of the body 100. Accordingly, when oil supplied from the camshaft 400 flows into the oil channel 700, it passes through the oil filtering member 300, so oil filtered through an oil filter (not shown) in an oil pump (not shown) passes through the oil filtering member 300 one more time, and accordingly foreign substances in the oil are filtered one more time. The present disclosure relates to the oil filtering member 300, so detailed flow of oil or the configuration or operation of the CVVT is not described in detail.

In one from the oil filtering member 300 is a mesh covering the end of the body 100 opposite to the head 500 and the size of the mesh may be 150˜200 μm×150˜200 μm. The reason for specifying the mesh size, as described above, is because when the size is smaller than the specified mesh size, oil flowing through the mesh drops in pressure, or when the size is larger than the specified mesh size, large foreign substances that may cause sticking and pass through the mesh and flow into the CVVT.

The oil filtering member 300 may cover the entire end of the body 100 opposite to the head 500, but the oil channel 700 is formed to the ends of the body 100 and the diameters of the oil filtering member 300 and the oil channel 700 are the same, so the oil filtering member 300 is forcibly fitted in the oil channel 700. Accordingly, the oil filtering member 300 is disposed at the inlet of the oil channel 700 and has a semi-spherical shape concaved inside the oil channel 700 at the end thereof. As the oil filtering member 300 has a semi-spherical shape, it is possible to increase the area where oil is filtered, and limiting interference of the flow of viscous oil through the oil filtering member.

According to the bolt valve of the present disclosure adding the oil filtering member provides one additional filtering of the oil supplied to the CVVT through the camshaft from the oil tank. The oil filtering member reduces the probability of foreign substances flowing into the CVVT, and reduces interference of the oil flow, thereby reducing the likelihood of sticking of the CVVT.

The above forms of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A bolt valve comprising:
a body having an oil channel longitudinally formed therein to discharge oil flowing in the oil channel; and
an oil filtering member disposed in the body for filtering oil flowing into the oil channel.

2. The bolt valve of claim 1, wherein a head is disposed at a first end of the body and the oil filtering member is disposed at a second end of the body.

3. The bolt valve of claim 1, wherein the oil filtering member is a mesh covering an end of the body.

4. The bolt valve of claim 3, wherein a size of the mesh is 150˜200 μm×150˜200 μm.

5. The bolt valve of claim 1, wherein the oil filtering member is fitted in the oil channel at an end of the body and positioned at an inlet of the oil channel.

6. The bolt valve of claim 1, wherein the oil filtering member has a semi-spherical shape concaved inside the oil channel at an end thereof.

7. The bolt valve of claim 1, wherein diameters of the oil filtering member and the oil channel are the same and the oil filtering member is forcibly fitted in the oil channel.
